(19) United States
(12) Patent Application Publication
(10) Pub. No.: US 2024/0140175 A1
(43) Pub. Date: May 2, 2024

(54) PERFORATED VEHICLE SCREEN

(71) Applicant: RL Patents, LLC, San Francisco, CA (US)

(72) Inventor: Ricky Lam, San Francisco, CA (US)

(21) Appl. No.: 18/385,895

(22) Filed: Oct. 31, 2023

Related U.S. Application Data
(63) Continuation of application No. 17/539,111, filed on Nov. 30, 2021.

(51) Int. Cl. B60J 1/00; B60J 1/20

(52) U.S. Cl. CPC B60J 1/008; B60J 1/2011

(57) ABSTRACT

Perforated vehicle screen including, e.g., windshield, rear window, side window, vent window, quarter pane, and/or roof panel. The perforation may comprise any pattern, such as, e.g., cross-hatch, linear, diagonal, circular hole, square hole, polygonal hole, rounded long hole, and/or angular long hole. The vehicle may be autonomous and does not require an operator. In some cases, the vehicle is not autonomous and requires an operator. The perforated screen may be in addition to, or in substitute of, standard glass. The perforated screen may be transparent, semi-transparent, or non-transparent. The perforated screen may be made from plastic, metal, and/or glass, and may be flexible or rigid. For example, the perforated screen may provide structure support to the vehicle. Each of the perforated vehicle screens may be formed in any shape and size to match a vehicle's specific dimensions based on make and model. In addition, a perforated vehicle screen may be convex, concave, or planar.

### FIELD OF TECHNOLOGY

This disclosure relates generally to a perforated vehicle screen.

### BACKGROUND

Vehicle glass may include, e.g., windshield, rear window, side window, vent window, quarter pane, and/or roof panel. A side window can be either fixed in position, or raised and lowered by depressing a button or switch, e.g., power window, or using a hand-turned crank. The power moonroof, a transparent, and retractable sunroof, may be considered as an extension of the power window concept. Some vehicles include sun blinds for rear and rear side windows. The majority of vehicle glass is held in place by glass run channels, which also serve to contain any fragments of glass if the glass breaks.

The windshield, or windscreen, of an automobile, aircraft, bus, motorbike, truck, train, boat or streetcar is the front window, which provides frontal visibility while protecting occupants from the elements, such as, e.g., wind, rain, dust, insets, and rocks. In the early days of automobiles, cars were manufactured with an open-air design. Since they didn't have windshields, drivers wore goggles to protect their eyes from wind and debris. This was inconvenient, so in 1904 the windshield was invented. The windshield became very important in protecting passengers from outdoor elements, particularly as cars became more powerful and could travel at faster speeds. The early windshields, unfortunately, were manufactured from glass that shattered upon impact. Since this led to an increase in injuries, an alternative was sought. Modern windshields are generally made of laminated safety glass, a type of treated glass, which comprises two curved sheets of glass with a plastic, e.g., vinyl, layer between them for safety, and bonded into the window frame. Laminated glass is strong like tempered glass, but bends slightly upon impact, allowing for additional protection against shattering. Laminated glass is now considered the safest type of auto glass, and is actually required by law in many countries, including the United States. The essential components of windshield glass are silica sand, soda ash, dolomite, limestone and cullet. Small quantities of potassium oxide and aluminium oxide are often added.

Back glass, also called rear window, rear windshield, or rear glass, is the piece of glass opposite the windshield in a vehicle. Back glass is made from tempered glass, also known as safety glass, which is the same as for the side window, vent window, and quarter pane. Tempering is a special heat treatment that makes the glass stronger and harder, so that it resists shattering. This piece of glass may contain heating coils or antennae, depending on the year, make, and model of the vehicle.

### SUMMARY

A perforated screen configured to be installed on a vehicle. The screen may be fixed in position or is adjustable. The screen may be flexible or rigid. The screen may be in substitute of, or in addition to, standard vehicle glass, such as, e.g., windshield, rear window, side window, vent window, quarter pane, and/or roof panel. When in addition to standard vehicle glass, the screen may be disposed on the exterior or interior of the vehicle's cabin. The screen may be transparent, semi-transparent, or non-transparent. The screen may be convex, concave, or planar. The perforation comprises a cross-hatch pattern, linear configuration, diagonal configuration, circular hole, square hole, polygonal hole, rounded long hole, an angular long hole, or any combination thereof. One or more openings of the perforation may permit airflow to enter the vehicle, and may not be permeable to external particles. The vehicle may be at least partially autonomous. In some cases, the vehicle is not autonomous and requires an operator.

### BRIEF DESCRIPTION OF THE DRAWINGS

Example embodiments are illustrated by way of example and are not limited to the figures of the accompanying drawings, in which, like references indicate similar elements.

FIG. 1 illustrates a side view of a representative vehicle.

FIG. 2 illustrates the side view of the representative vehicle with perforated vehicle screens.

FIGS. 3A-3F shows various configurations for a perforated vehicle screen. Any other shapes, sizes, patterns, and orientations may be employed.

FIGS. 4A-4F are diagrams of various vehicle glass locations where a perforated vehicle screen may be installed on a representative vehicle.

FIG. 5 illustrates a marked unconventional window on the vehicle.

### DETAILED DESCRIPTION

Although the present has been described with reference to specific examples, it will be evident that various modifications and changes may be made without departing from the broader spirit and scope of the various examples. The modifications and variations include any relevant combination of the disclosed features. In addition, the components shown in the figures, their connections, couplings, relationships, and their functions, are meant to be exemplary only, and are not meant to limit the examples described herein.

Perforated vehicle screen including, e.g., windshield, rear window, side window, vent window, quarter pane, and/or roof panel. The perforation may comprise any pattern, such as, e.g., cross-hatch, linear, diagonal, circular hole, square hole, polygonal hole, rounded long hole, and/or angular long hole. Vehicle may include, e.g., automobile, aircraft, bus, motorbike, truck, golf cart, train, maritime, streetcar, personal transport vehicle (PTV), and low speed vehicle (LSV). The vehicle may be autonomous and does not require an operator. In some cases, the vehicle is not autonomous and requires an operator. The perforated screen may be in addition to, or in substitute of, standard glass. The perforated screen may be fixed in position such that it is non-adjustable and immovable. In some cases, the perforated screen may be adjustable, such as, e.g., having the ability to roll up and roll down. When in addition to standard glass, the perforated screen may be disposed on the interior or the exterior of the vehicle's cabin. The perforated screen may be transparent, semi-transparent, or non-transparent. The perforated screen may be made from plastic, metal, and/or glass, and may be flexible or rigid. For example, the perforated screen may provide structure support to the vehicle. Each of the perforated vehicle screens may be formed in any shape and size to match a vehicle's specific dimensions based on make and model. In addition, a perforated vehicle screen may be convex, concave, or planar.

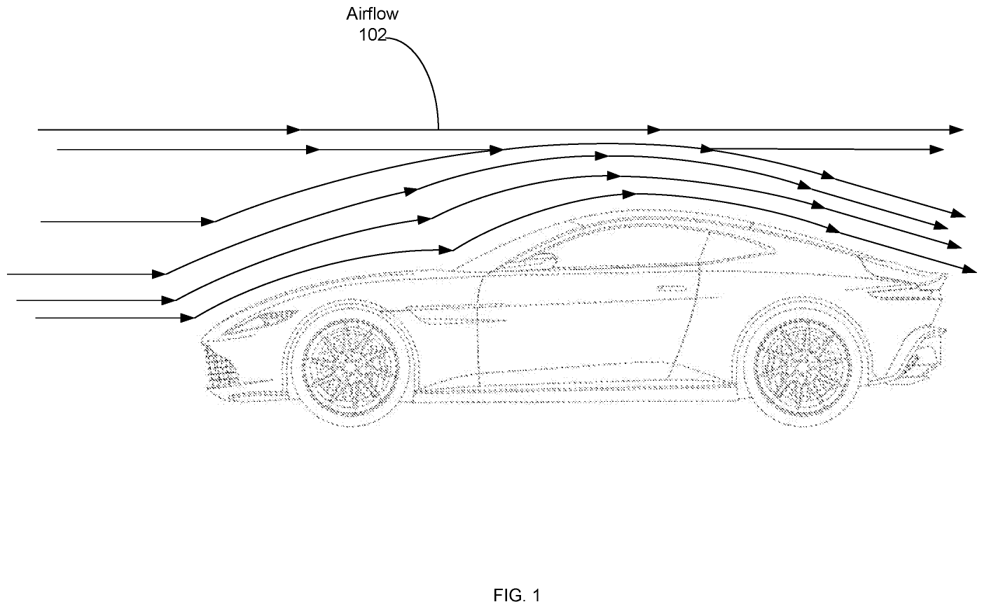

FIG. 1 illustrates a side view of a representative vehicle. Although an automobile is shown, any other type of vehicle is applicable. On the exterior, the automobile may comprise one or more auto glass, doors, a hood, wheels, front and rear bumpers, side mirrors, an exhaust system, and external lighting. On the interior, the automobile may comprise an engine, a transmission, seats, a steering wheel, an electronic console, and internal lighting. The automobile may be designed to maximize aerodynamic efficiency, such as, e.g., to overcome drag. For example, airflow 102 may be configured to, e.g., reduce surface friction and resistance, frontal pressure, and/or rear vacuum, by completely encapsulating the vehicle in a smooth and stable fashion as it moves through the air.

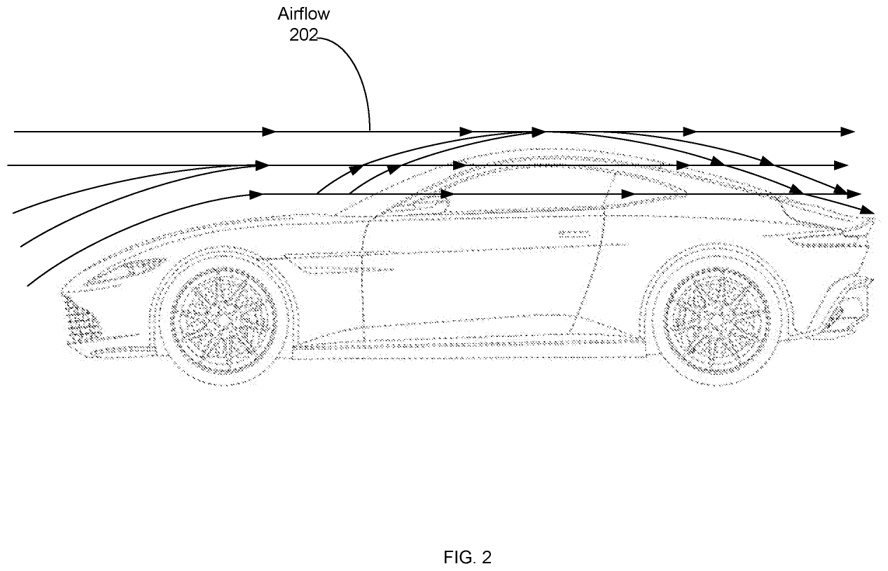

FIG. 2 illustrates the side view of the representative vehicle with perforated vehicle screens. Instead of completely encapsulating the vehicle, airflow 202 is now divided among a portion encapsulating the vehicle and another portion flowing through the vehicle via openings of the one or more screens, such as, e.g., windshield, rear window, side window, vent window, quarter pane, and/or roof panel. The amount and manner of internal airflow 202 through the vehicle may be determined by the type of perforation, such as, e.g., cross-hatch, linear, diagonal, circular hole, square hole, polygonal hole, rounded long hole, and/or angular long hole. The amount of internal airflow 202 through the vehicle may be directly proportional to perforation size. For example, a perforated vehicle screen comprising one or more perforations of a predetermined size may have a larger amount of internal airflow 202 through the vehicle than compared to another perforated vehicle screen comprising one or more relatively smaller perforations. In addition, the cumulative size of a plurality of perforations on a vehicle screen may be directly proportional to the amount of internal airflow 202 through the vehicle. For example, a single perforation of a predetermined size on a vehicle screen may have a larger amount of internal airflow 202 through the vehicle than a plurality of smaller perforation that has a cumulative size that is less than the predetermined size of the single perforation. The vehicle may be autonomous and does not require an operator such that internal airflow 202 through the vehicle does not affect driving ability. In some cases, the vehicle is not autonomous and requires an operator.

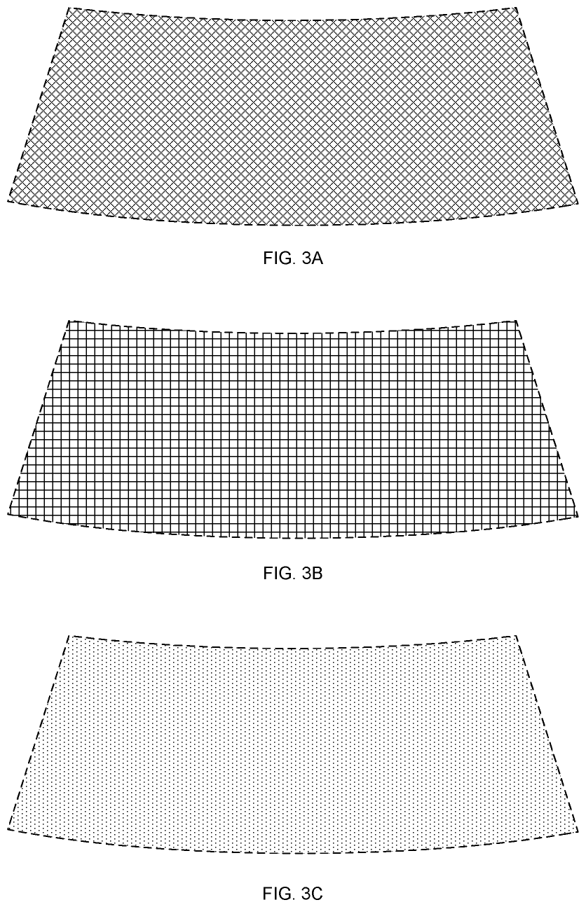

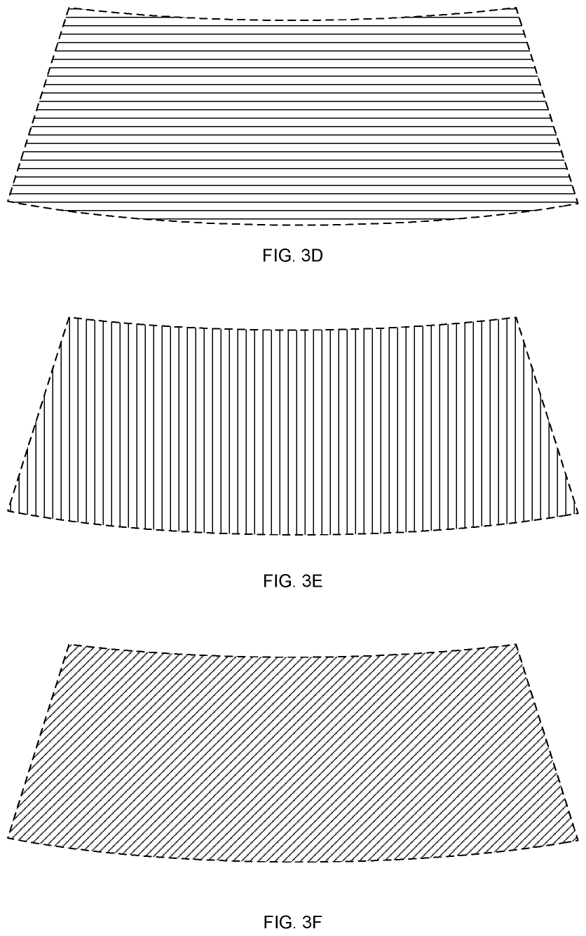

FIGS. 3A-3F shows various configurations for a perforated vehicle screen. Any other shapes, sizes, patterns, and orientations may be employed. Although a windshield is used to illustrate an example context for the perforated vehicle screen, any other vehicle screen may include the perforated screen, such as, e.g., rear window, side window, vent window, quarter pane, and/or panel roof. In FIG. 3A, the perforation may be configured in a cross-hatch pattern. A cross-hatch pattern may be defined by two sets of parallel lines that intersect. The intersections may define the corners of a square-shape space between the parallel lines. For example, the diamond-shape space may include four diagonal or slanted perimeter lines. FIG. 3B is a variation of the cross-hatch pattern of FIG. 3A. In this figure, the square-shape space between the parallel lines may include four perimeter lines that are horizontal and vertical instead of diagonal or slanted, relative to a viewer standing or sitting upright. FIG. 3C shows a dot-matrix pattern of perforations on a perforated screen. The dot-matrix may comprise any configuration, such as, e.g., circular hole, square hole, polygonal hole, rounded long hole, and/or angular long hole. The dot-matrix may be evenly space, or unevenly spaced. For example, perforations may be evenly disbursed such that distance from one opening to another is equal, or the perforations may be unevenly disbursed such that distance from one opening to another is unequal.

FIG. 3D illustrates perforations that are configured in parallel horizontal lines relative to a viewer standing or sitting upright. The horizontal lines may be equidistant or space unequally from one another. In some cases, the horizontal lines may be both equidistant and spaced unequally from one another such that a portion of a vehicle screen includes equidistant lines and another portion of the vehicle screen includes unequally spaced lines. FIG. 3E illustrate perforations that are configured in parallel vertical lines relative to a viewer standing or sitting upright. The vertical lines may be equidistant or space unequally from one another. In some cases, the vertical lines may be both equidistant and spaced unequally from one another such that a portion of a vehicle screen includes equidistant lines and another portion of the vehicle screen includes unequally spaced lines. FIG. 3F illustrates perforations that are configured in parallel diagonal lines relative to a viewer standing or sitting upright. The diagonal lines may be equidistant or space unequally from one another. In some cases, the diagonal lines may be both equidistant and spaced unequally from one another such that a portion of a vehicle screen includes equidistant lines and another portion of the vehicle screen includes unequally spaced lines. The diagonal lines may be of any degree angle and direction. For example, the line may start at an upper right hand side portion of a vehicle screen and extend to a lower left hand side portion of the screen. Conversely, the line may start a lower left hand side portion of a vehicle screen and extend to an upper right hand side portion of the screen.

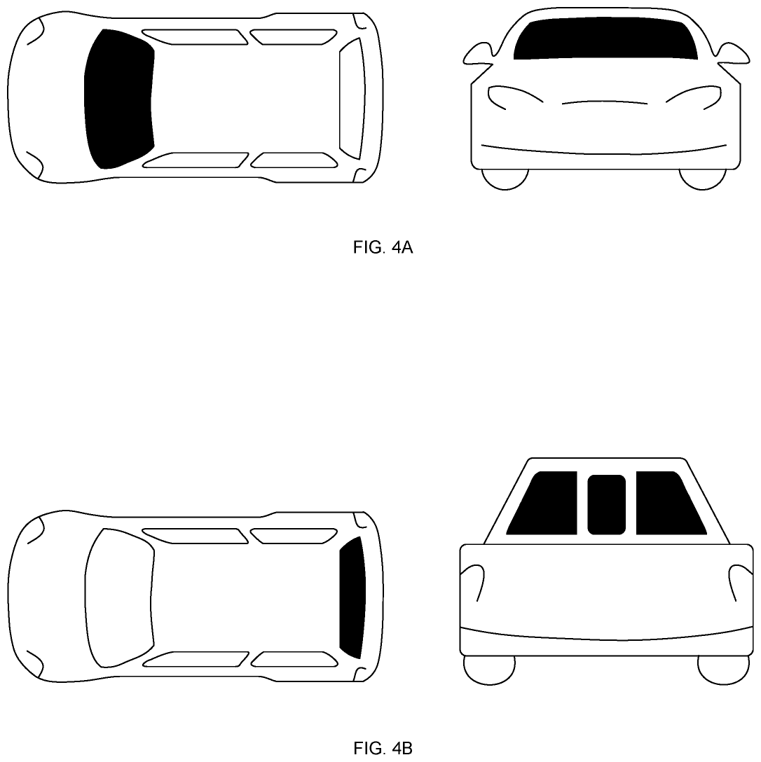

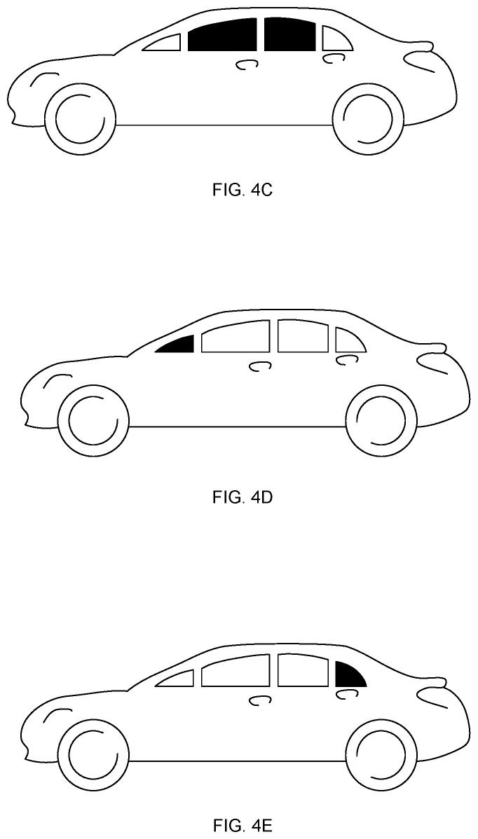

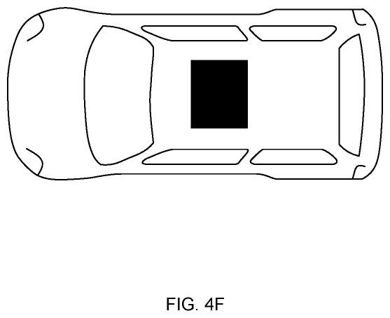

FIGS. 4A-4F are diagrams of various vehicle glass locations where a perforated vehicle screen may be installed on a representative vehicle. The perforated screen may be in addition to, or in substitute of, standard glass. The perforated screen may be fixed in position such that it is non-adjustable and immovable. In some cases, the perforated screen may be adjustable, such as, e.g., having the ability to roll up and roll down. When in addition to standard glass, the perforated screen may be disposed on the interior or the exterior of the vehicle's cabin. The perforated screen and may be transparent, semi-transparent, or non-transparent. The perforated screen may be made from plastic, metal, and/or glass, and may be flexible or rigid. One or more openings of the perforated screen may be configured to minimize or eliminate external particles from entering the vehicle, such as, e.g., rocks, dust and insects. For example, the openings may be sized to only allow airflow to enter. Each of the perforated vehicle screens may be formed in any shape and size to match a vehicle's specific dimensions based on make and model. In addition, a perforated vehicle screen may be convex, concave, or planar.

In FIG. 4A, a windshield on the vehicle is marked. The windshield, or windscreen, of an automobile, aircraft, bus, motorbike, truck, train, boat or streetcar is the front window, which provides frontal visibility while protecting occupants from the elements. In the early days of automobiles, cars were manufactured with an open-air design. Since they didn't have windshields, drivers wore goggles to protect their eyes from wind and debris. This was inconvenient, so in 1904 the windshield was invented. The windshield became very important in protecting passengers from outdoor elements, particularly as cars became more powerful and could travel at faster speeds. As autonomous vehicles are becoming popular, passengers are no longer required to shield their eyes from wind and debris as an operator is not required. Perforated vehicle screens allow drivers to enjoy a breeze of fresh air that is free of particles that can harm them, such as, e.g., rocks, dust and insects. A perforated vehicle screen of a windshield may comprise one or more enhancements, such as, e.g., antenna, rain sensor, hydrophobic coating, heads-up display (HUD), lane departure warning system, light sensor, night vision, and/or solar control.

FIG. 4B shows a marked rear window of the vehicle. The rear window is located opposite of the windshield in the back of the vehicle. A perforated vehicle screen of a rear window may permit airflow coming through the windshield to flow out of the rear of the vehicle, thereby increasing overall internal airflow of the vehicle. The rear window may include “sliders” that are typically found in trucks. FIG. 4C shows marked side windows of the vehicle. Side windows may include two pairs, such as, e.g., front and rear side windows. In some cases, there may only be a single pair of side windows. Side windows may provide side visibility for passengers. A perforated vehicle screen of side windows may permit airflow coming through the windshield to flow out of the pertinent side of the vehicle, thereby increasing overall internal airflow of the vehicle. FIG. 4D and FIG. 4E show a marked vent window and a marked quarter pane window, respectively. The vent window may be disposed at a front portion of the vehicle, behind the windshield. The quarter pane window may be disposed at a rear portion of the vehicle, in front of the rear window. The vent window and the quarter pane window may provide additional side visibility for passengers. A perforated vehicle screen of the vent window and the quarter pane window may permit airflow coming through the windshield to flow out of the pertinent screen, thereby increasing overall internal airflow of the vehicle. FIG. 4F shows a marked roof window of the vehicle. A perforated vehicle screen of the roof window may permit airflow coming through the windshield to flow out of the roof of the vehicle, thereby increasing overall internal airflow of the vehicle.

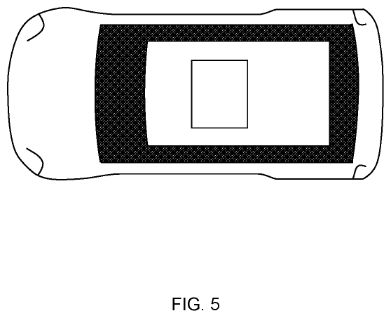

FIG. 5 illustrates a marked unconventional window on the vehicle. The window may include one or more perforated screens, and may horizontally surround passengers giving them a 360-degree view of the environment. The perforation permits passengers to be cooled in all directions. The window may be constructed as a single-piece structure, or it may comprise multiple windows disposed next to one another. For example, there may be no structural division between each window.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other examples are within the scope of the following claims.

It may be appreciated that the various systems, methods, and apparatus disclosed herein may be configured in a machine-readable medium and/or a machine accessible medium, and/or may be performed in any order. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A system, comprising:
a vehicle comprising one or more perforated screens, and
wherein the one or more perforated screens are permitted to roll up and roll down.

2. The system of claim 1:
wherein the one or more perforated screens are flexible.

3. The system of claim 1:
wherein the one or more perforated screens are rigid.

4. The system of claim 1:
wherein the one or more perforated screens are in substitute of standard vehicle glass, and
wherein the vehicle does not include standard vehicle glass.

5. The system of claim 1:
wherein the one or more perforated screens are in substitute of a standard vehicle windshield.

6. The system of claim 1:
wherein the one or more perforated screens are in substitute of a standard vehicle rear window.

7. The system of claim 1:
wherein the one or more perforated screens are transparent, semi-transparent, or non-transparent.

8. The system of claim 1:
wherein the one or more perforated screens are convex.

9. The system of claim 1:
wherein the one or more perforated screens are concave.

10. The system of claim 1:
wherein the perforation comprises a cross-hatch pattern.

11. The system of claim 1:
wherein the vehicle is autonomous.

12. A system, comprising:
a vehicle comprising one or more perforated screens; and
wherein the one or more perforated screens are fixed in position and immovable.

13. The system of claim 12:
wherein the one or more perforated screens are flexible.

14. The system of claim 12:
wherein the one or more perforated screens are rigid.

15. The system of claim 12:
wherein the one or more perforated screens are in addition to standard vehicle glass.

16. The system of claim 15:
wherein the standard vehicle glass comprises a windshield.

17. The system of claim 15:
wherein the standard vehicle glass comprises a rear window.

18. The system of claim 12:
wherein the one or more perforated screens are convex, concave, or planar.

19. The system of claim 12:
wherein the vehicle is autonomous.

20. The system of claim 12:
wherein the perforation comprises a plurality of circular holes.
